(19) United States
(12) Patent Application Publication
(10) Pub. No.: US 2026/0051134 A1
(43) Pub. Date: Feb. 19, 2026

(54) METHOD AND SYSTEM FOR TEXT PRESENTATION IN AN AUGMENTED REALITY (AR) BASED DEVICE

(71) Applicant: Samsung Electronics Co., Ltd., Suwon-si (KR)

(72) Inventors: Gunit ANAND, Noida Uttar Pradesh (IN); Nitin JAIN, Noida Uttar Pradesh (IN); Shreya YADAV, Noida Uttar Pradesh (IN)

(21) Appl. No.: 19/279,668

(22) Filed: Jul. 24, 2025

Related U.S. Application Data
(63) Continuation of application No. PCT/KR2025/009451, filed on Jul. 2, 2025.

(30) Foreign Application Priority Data
Aug. 16, 2024 (IN) 202411062173

(51) Int. Cl. G06T 19/00; G06F 3/04842; G06F 16/34

(52) U.S. Cl. CPC G06T 19/006; G06F 3/04842; G06F 16/345

(57) ABSTRACT

The disclosure relates to a method and a system for text presentation in an augmented reality (AR) based device. The method comprises: identifying one or more layout types for a complete text; restructuring the complete text based on one or more visual see through (VST) parameters, the one or more layout types, and a text occupancy per degree value; identifying a text position for the restructured text based on at least one of: one or more user parameters, one or more user activities, and the one or more VST parameters; and presenting the restructured text based on the identified text position.

### CROSS-REFERENCE TO RELATED APPLICATIONS

This application is a continuation of International Application No. PCT/KR2025/009451 designating the United States, filed on Jul. 2, 2025, in the Korean Intellectual Property Receiving Office and claiming priority to Indian Patent Application No. 202411062173, filed on Aug. 15, 2024, in the Indian Patent Office, the disclosures of each of which are incorporated by reference herein in their entireties.

### BACKGROUND

### Field

The disclosure relates to augmented reality (AR) based devices. For example, the disclosure relates to a method and a system for text presentation in an augmented reality (AR) based device.

### Description of Related Art

The following description of the related art is intended to provide background information pertaining to the field of the disclosure. This section may include certain aspects of the art that may be related to various features of the present disclosure. However, it should be appreciated that this section is used simply to enhance the understanding of the reader with respect to the present disclosure, and is not as admissions of the prior art.

As society progresses and the proliferation of technology in daily lives of people takes place, there has been an increasing reliance on various electronic devices, such as smartphones, personal digital assistants (PDAs), for performing various interactions and acquisition of diverse types of information. These devices facilitate various functions, including telephony, interpersonal communication, web browsing, data aggregation, etc. The interaction between users and these electronic systems is mediated through an extensive range of input and output mechanisms. Traditional hardware interfaces include devices like keyboards and mouse, and more recent interfaces encompass touch-sensitive screens and similar touch-sensitive user interfaces. However, these ways of interacting with computers were not sufficient for the dynamically changing demands and requirements. The current requirements need future interactions to be as natural, precise, and quick as talking to another person. Thus, multiple ways are being explored to interact with computers, that is, for Human-Machine Nature Interaction (HMNI), which aims to make interactions with computers more like real human conversations. This has led to the development of advanced devices such as augmented reality (AR) based, virtual reality (VR) based devices that facilitate more immersive experience as well as enhanced data selection and presentation, with the desired experience as per the need.

Virtual reality (VR), augmented reality (AR), and mixed reality (MR) technologies are becoming more and more common as the availability of VR, AR, and MR headsets and other devices continues to expand. Further, the rise of AR/VR/MR promises immersive experiences for the user and is being a growing trend in the technological shift.

Virtual reality (VR) refers to a technology that constructs an artificial simulation or replica of an environment, which may be either real or entirely fictional. VR technology generates a three-dimensional virtual world through computer simulations. It delivers sensory feedback including visual, auditory, and sometimes haptic stimuli, creating the illusion that users are immersed in and interacting with a three-dimensional virtual space. VR can produce simulations that extend beyond real-world constraints. This evolving technology integrates multimedia components, utilizing advanced three-dimensional graphics, multi-sensory interaction mechanisms, and high-resolution displays to create realistic and immersive virtual environments.

Augmented Reality (AR) refers to a technology that overlays computer-generated content onto a real-world environment, enhancing the user's perception and interaction with their surroundings. This technology represents an advancement in the field of virtual reality, often classified under the broader category of mixed reality. In AR systems, digital information such as images, sounds, or data is integrated with the physical world in real-time. This is achieved through various sensors, such as cameras and depth sensors, which capture the user's real-world environment. The AR system then processes this data and projects relevant virtual elements onto the real-world view. The objective of AR is to augment the user's experience of reality by embedding contextual information and interactive elements into their immediate environment. For instance, AR can overlay digital maps, navigation cues, or product information onto the user's field of view, thereby enriching their interaction with the physical world. By superimposing virtual subjects or data onto real-world scenes, AR provides an enhanced perception of reality, facilitating more immersive and informative user experiences.

Mixed Reality (MR) encompasses a technology where computer-generated content is either superimposed upon or fully integrates with a real-world environment. This technology merges virtual and real-world elements, creating a hybrid experience where digital objects are anchored to, and interact with, physical objects in the user's actual surroundings.

In existing situations for AR scenes, an augmented reality scene is realized when a device is used to overlay a scene rendered using computer-generated graphics onto a real world scene into a single combined scene. This scene may also include textual data visible in the surroundings. Reading a text in an AR environment becomes a difficult task at times due to several factors, such as limited field of view, luminosity, writing style, low contrast, and hazy nature, and the text often becomes unreadable due to improper processing, improper cropping, large amount of redundant text present in the field of view, thus making the performance of various tasks cumbersome and inefficient. Text Presentation in the AR based devices such as, visual see through (VST) glasses, happens on the basis of the amount of the content shown at once to user. However, presenting the text in an efficient way is still a hurdle. Unlike traditional screens, the displays of these AR based devices have a limited field of view, restricting readable text. Users expect all important textual data in their field of view while using the VST devices. When large textual data is presented on the display, it gets cropped out, for example, in way that useful information is not visible and cropped out, and the users are unable to get full information at once due to limited Field of View of the VST glasses. In another example, due to real world as background, the camouflaging/improper presentation of the textual content happens which leads to poor readability of the text. In another example, when a user wear VST glasses and walks while watching some content on the VST glasses, the content might shake and/or get blurred during walking or performing any such activity. In another example, a user wears VST glasses and listens to an audio book in an unfamiliar language. The audio of this unfamiliar language is converted into text, translated into a user preferred language and presented to the user to read. However, as more text is added on the screen, or the user turns his/her head for more content, the user is unable to see the content due to limited field of view (FOV) on the VST glasses.

Thus, as noted above, when a user consumes large amount of textual content, or poorly presented textual content, then there is readability issue with the content which leads to increase in cognitive load on the user for understanding the content. This is due to various reasons such as: when the user consumes large content on limited field of view then it leads to the cropping of the content; when the user consumes content having certain typographic properties with respect to background which leads to visibility issue with the content like camouflaging of the content in the background scene/colours; when the user consumes content while performing any activity then it sometimes leads to presentation issues of the content.

In one of the existing solutions related to automated text simplification for task guidance in augmented reality, a few-shot prompt and large language models are used to specifically optimize the text length and semantic content for augmented reality. However, this method is limited to simplification of specific task based lengthy text. It does not consider small text and various other significant parameters to enhance visibility of the content. Another existing solution relates to estimating visibility of annotations for view management in spatial augmented reality. This solution focuses on correctness of recognizing a text and linking the label to an object. Based on the visibility of object and understanding of text, the labels are assigned and placed. However, this method is limited to recognizing and linking label to an object. It does not consider displaying and visibility of content information like application window to user as an anchored frame in real world space. Also, this method does not simplify and remove the unwanted content and does not consider various significant parameters to enhance visibility of the content.

As noted above, the current generation of augmented reality (AR) based systems and methods (especially those for presentation of textual data) are inefficient due to inadequate analysis and understanding of input data, inferior data integration quality, and lack of interactive controls between a user, AR-based data, and the physical world. Thus, there exists a need for a technical solution that can address at least the above-mentioned technical limitations of the existing solutions. For example, there is a need in the art to provide a method and system for text presentation in an augmented reality (AR) based device.

### SUMMARY

According to an example of the present disclosure a method for text presentation in an augmented reality (AR) based device is provided. The method comprises” identifying one or more layout types for a complete text; restructuring the complete text based on one or more visual see through (VST) parameters, the one or more layout types, and a text occupancy per degree value; identifying a text position for the restructured text based on at least one of: one or more user parameters, one or more user activities, and the one or more VST parameters; and presenting the restructured text based on the identified text position.

According to an example embodiment of the present disclosure, the identifying the text position further comprises identifying a location and an anchoring type for the restructured text.

According to an example embodiment of the present disclosure, the presenting of the restructured text is further based on one or more content parameters.

According to an example embodiment of the present disclosure, the one or more content parameters are based on one or more of: a set of typographic parameters, an AR device rendered environment parameters, a content density per degree of field-of-view (FOV), and a real world environment parameters.

According to an example embodiment of the present disclosure, the restructuring the complete text comprises extracting a relevant text from the complete text for display, based on a visual context, the one or more content parameters, and at least a subset of the one or more VST parameters.

According to an example embodiment of the present disclosure, the identifying the text position is based on: (a) a segmentation of one or more sentences in the restructured text to generate one or more text segments; and (b) an alignment of the one or more text segments.

According to an example embodiment of the present disclosure, the method further comprises: a text simplification of the one or more text segments, a text reduction of the one or more text segments, and a text paraphrasing of the one or more text segments, wherein the text simplification, the text reduction, and the text paraphrasing are based on a complexity analysis of the one or more text segments.

According to an example embodiment of the present disclosure, the presenting the restructured text further comprises: (a) comparing a text simplification value of the one or more text segments with a pre-defined text simplification threshold value; and (b) generating a text simplification score based on the comparison.

According to an example embodiment of the present disclosure, the presenting the restructured text further comprises: (a) comparing a text positioning value of the one or more text segments with a pre-defined text positioning threshold value; and (b) generating a text positioning score based on the comparison.

According to an example embodiment of the present disclosure, the presenting the restructured text further comprises: (a) comparing a text visibility value of the one or more text segments with a pre-defined text visibility threshold value; and (b) generating a text visibility score based on the comparison.

According to an example embodiment of the present disclosure, prior to identifying the one or more layout types for the complete text, the method comprises extracting the one or more VST parameters, the one or more layout types, the one or more user parameters, the one or more user activities, and the one or more content parameters.

According to an example embodiment, the present disclosure may relate to a system for text presentation in an augmented reality (AR) based device. The system comprises: at least one processor, comprising processing circuitry, and at least one memory unit comprising a memory connected to the at least one processing unit, wherein at least one processor, individually and/or collectively, is configured to: identify one or more layout types for a complete text; restructure the complete text based on one or more visual see through (VST) parameters, the one or more layout types, and a text occupancy per degree value; identify a text position for the restructured text based on at least one of: one or more user parameters, one or more user activities, and the one or more VST parameters; and present the restructured text based on the identified text position.

According to an example embodiment, the present disclosure may relate to a non-transitory computer-readable storage medium storing instructions for text presentation in an augmented reality (AR) based device. The instructions include executable code which, when executed by at least one processor, comprising processing circuitry, individually and/or collectively, of a system, causes the system to: identify one or more layout types for a complete text; restructure the complete text based on one or more visual see through (VST) parameters, the one or more layout types, and a text occupancy per degree value; identify a text position for the restructured text based on at least one of: one or more user parameters, one or more user activities, and the one or more VST parameters; and present the restructured text based on the identified text position.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of a system for text presentation in an augmented reality (AR) based device, according to various embodiments;

FIG. 2 is a block diagram illustrating example modules/units for text presentation in an AR based device, according to various embodiments;

FIG. 3 is a flowchart illustrating an example method for text presentation in an AR based

### Device, According to Various Embodiments;

FIG. 4 is a block diagram illustrating an example configuration of an analyzer and extraction unit, according to various embodiments;

FIG. 5 is a block diagram illustrating an example configuration of a complexity analysis and segmentation unit, according to various embodiments; and

FIG. 6 is a block diagram illustrating an example configuration of output unit, according to various embodiments.

### DETAILED DESCRIPTION

In the following description, for the purposes of explanation, various specific details are set forth in order to provide a thorough understanding of various embodiments of the present disclosure. It will be apparent, however, that the present disclosure may be practiced without these specific details. Several features described hereafter may each be used independently of one another or with any combination of other features. An individual feature may not address any of the problems discussed above or might address only some of the problems discussed above.

The ensuing description provides various example embodiments, and is not intended to limit the scope, applicability, or configuration of the disclosure. Rather, the description of the example embodiments will provide those skilled in the art with an enabling description for implementing various example embodiments. It should be understood that various changes may be made in the function and arrangement of elements without departing from the spirit and scope of the disclosure as set forth.

It will be understood that various embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in the diagram.

The word “exemplary” and/or “demonstrative” is used herein to refer, for example, to serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, “a user equipment”, “a user device”, “a smart-user-device”, “a smart-device”, “an electronic device”, “an augmented reality (AR) based device” may be any electrical, electronic and/or computing device or equipment, capable of implementing the features of the present disclosure. The user equipment/device may include, but is not limited to, a wearable device or any other computing device which is capable of implementing the features of the present disclosure. The user device may contain at least one input means configured to receive an input from unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As used herein, a “user interface” typically includes various interface circuitry including, for example, an output device in the form of a display, such as a liquid crystal display (LCD), cathode ray tube (CRT) monitors, light emitting diode (LED) screens, etc. and/or one or more input devices such as touchpads or touchscreens. The display may be a part of a portable electronic device such as smartphones, tablets, mobile phones, wearable devices, etc. They also include monitors or LED/LCD screens, television screens, etc. that may not be portable. The display is typically configured to provide visual information such as text and graphics. An input device is typically configured to perform operations such as issuing commands, selecting, and moving a cursor or selector in an electronic device.

All modules, units, components used herein, unless explicitly excluded herein, may be software modules or hardware modules, the processors being a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASIC), Field Programmable Gate Array circuits (FPGA), any other type of integrated circuits, etc. The processor may perform signal coding data processing, input/output processing, and/or any other functionality that enables the working of the system according to the present disclosure. For example, the processor or processing unit is a hardware processor.

One or more of the plurality of modules may be implemented through an AI model. A function associated with AI may be performed through the non-volatile memory, the volatile memory, and the processor. The processor may include one or a plurality of processors. For implementing the one or the plurality of modules through an AI model, the one or the plurality of processors may be a general purpose processor(s), such as a central processing unit (CPU), an application processor (AP), or the like, a graphics-only processing unit such as a graphics processing unit (GPU), a visual processing unit (VPU), and/or an AI-dedicated processor such as a neural processing unit (NPU). Thus, the processing unit or processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions. The one or the plurality of processors may control the processing of the input data in accordance with a predefined operating rule or artificial intelligence (AI) model stored in the non-volatile memory and the volatile memory. The predefined operating rule or artificial intelligence model is provided through training or learning. Being provided through learning may refer, for example, to, by applying a learning algorithm(s) to a plurality of learning data, a predefined operating rule or AI model of a desired characteristic being made. The learning may be performed in a device itself in which AI according to an embodiment is performed, and/or may be implemented through a separate server/system. The AI model may include a plurality of neural network layers, such as long short-term memory (LSTM) layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

A learning algorithm may refer to a method for training a device (for example, a robot) using a plurality of learning data to cause, allow, or control the device to make a determination or prediction. Examples of learning algorithms include, but are not limited to, supervised learning, unsupervised learning, semi-supervised learning, or reinforcement learning.

As discussed in the background section, existing technologies related to text presentation in an augmented reality (AR) based devices have many limitations, such as when a user consumes large amount of textual content, or in case of poorly presented textual content, there is readability issue with the content which leads to increase in cognitive load on the user for understanding the content. In order to address at least some of the limitations of the prior known solutions which may arise due to various reasons including inefficiency due to inadequate analysis and understanding of input data, inferior data integration quality, and lack of interactive controls between a user, AR-based data, and the physical world, the present disclosure provides various embodiments for text presentation in an AR based devices. In order to do this, the disclosure includes extracting parameters from user, visual see through (VST) glasses (or as used herein, AR based device or augmented reality based device), content, and background (e.g., real world). This comprises extracting parameters from a received input for the context, analysis of the received input content, and text extraction along with view group extraction from the received input content. Further, the disclosure comprises simplifying text, and modifying content parameters for restructuring and positioning of the text. This comprises complexity analysis of the content, text reduction, simplification, paraphrasing, and score generation based on various parameters, and visibility checking for enhancing visibility of the content. Further the disclosure comprises rendering the final text with restricted text as well repositioned for better visibility along with visibility enhancement based on various threshold values.

Hereinafter, various example embodiments of the present disclosure will be described in greater detail with reference to the accompanying drawings.

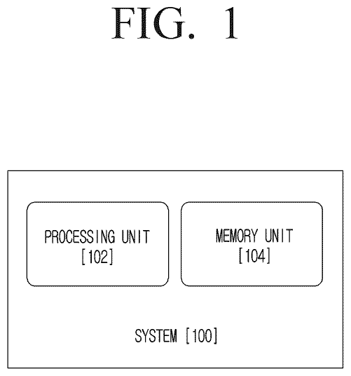

FIG. 1 is a block diagram illustrating an example configuration of a system [100] for text presentation in an AR based devices, according to various embodiments. The system [100] comprises at least one processing unit (e.g., at least one processor, including processing circuitry)

, and at least one memory unit (e.g., including a memory) [104] (or as used herein, storage unit [104]). The components/units of the system [100] are assumed to be connected to each other unless indicated below. As shown in the figure all units shown within the system [100] should also be assumed to be connected to each other. In FIG. 1 a few units are shown, however, the system

may comprise multiple such units, or the system [100] may comprise any such numbers of said units, as required to implement the features of the present disclosure. Further, in an implementation, the system [100] may be connected to or may reside in a user device which may be an augmented reality based device, such as a VST glasses.

The processing unit [102] may include various processing circuitry, e.g., at least one processor, and is configured to identify one or more layout types for a complete text. The terms “processing unit”, “processor”, “processor comprising processing circuitry”, “at least one processor”, or the like, may be used interchangeably herein and covers the processor(s) as described above. This layout type, in an example implementation, may be understood as a view group type, such as, but not limited to, a text view, a web view, and a scroll view. The processing unit [102] is configured to restructure the complete text based on one or more visual see through (VST) parameters, the one or more layout types, and a text occupancy per degree value. The one or more VST parameters comprise parameter(s) such as, but not limited to, field of view (FOV), resolution, and/or halation. The processing unit [102] is configured to identify a text position for the restructured text based on at least one of: one or more user parameters, one or more user activities, and the one or more VST parameters. The text position may further comprise a location (e.g., an anchoring location for a text) and an anchoring type for the restructured text. The user parameters may be based on head movement, and body movement, such as that while sitting, walking, etc., and the user activities may comprise activities such as, but not limited to, scrolling, typing, object interaction (such as, pinching the screen, virtually touching subjects seen in VST glasses, etc.). The extracted parameters, in an implementation, may be saved in the memory unit for further use. Further, the processing unit [102] is configured to present the restructured

### Text Based on the Identified Text Position.

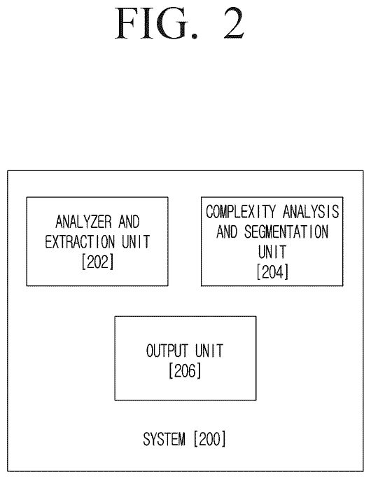

FIG. 2 is a block diagram illustrating an example configuration of the system [200] comprising various example modules for text presentation in an AR based device, according to various embodiments. The system [200], in an implementation, comprises various example modules/units/engines to implement one or more features of the present disclosure. The example modules as shown in FIG. 2, in an implementation, may be implemented by the processing unit

of the system [100]. As shown in FIG. 2, the system [200] comprises an analyzer and extraction unit (AEU) [202], a complexity analysis and segmentation unit (CASU) [204], and an output unit (OU) [206], each of which may include various circuitry and/or executable program instructions. Each of these units/modules/engines are explained in greater detail with reference to one or more figures in the forthcoming description.

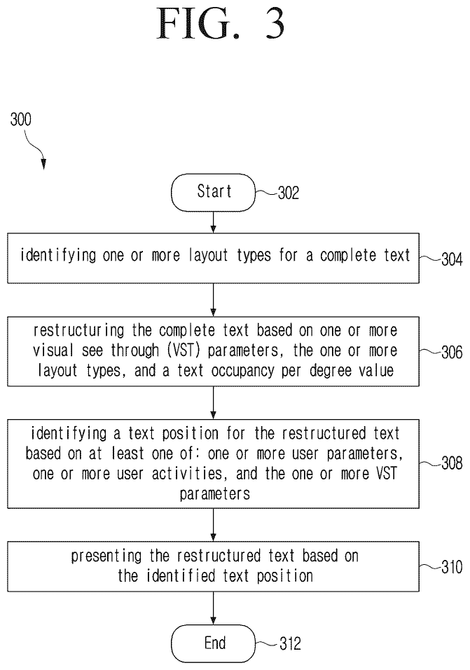

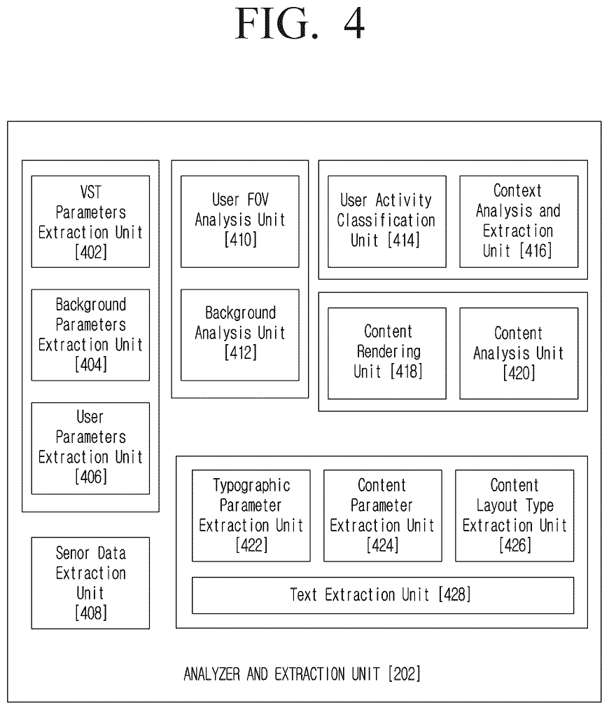

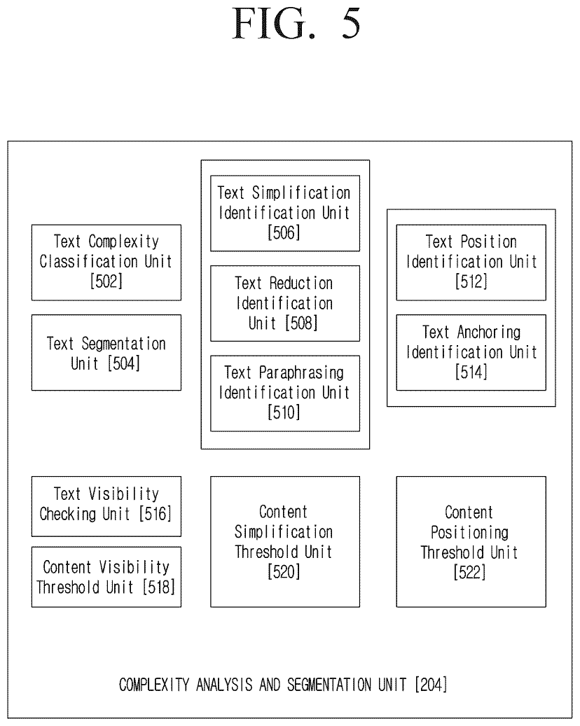

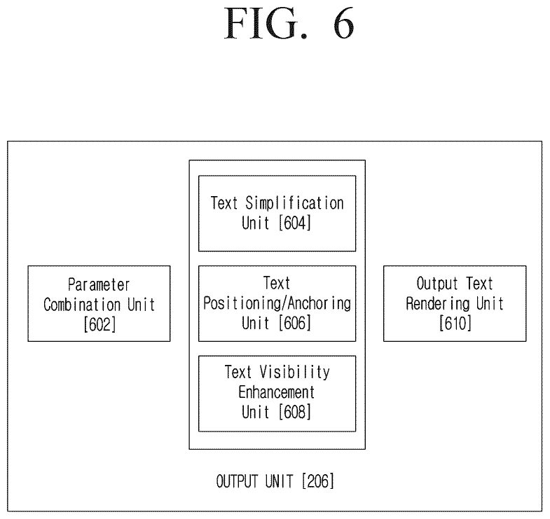

FIG. 3 is a flowchart illustrating an example method [300] for text presentation in an AR based device, according to various embodiments. In an implementation, the method [300] may be performed by the system [100]. The method [300] may be performed by the system [200] in conjunction with the system [100]. As shown in FIG. 3, the method [300] may start at step 302, and continue to step 304. It may be understood that the method [300] is triggered at step 302 where a user may wear and use the AR based device, such as the VST glasses for reading text in an AR environment.

At step 304, the method comprises identifying one or more layout types for a complete text. In an implementation, prior to identifying the one or more layout types for the complete text, the method comprises extracting one or more visual see through (VST) parameters, the one or more layout types, one or more user parameters, one or more user activities, and one or more content parameters. The AEU [202] may be used by the processing unit [102], the details of which are provided below with reference to FIG. 4.

At step 306, the method comprises restructuring the complete text based on the one or more visual see through (VST) parameters, the one or more layout types, and a text occupancy per degree value. The restructuring the complete text may include extracting a relevant text from the complete text for display, based on a visual context, one or more content parameters, and at least a subset of the one or more VST parameters. The CASU [204] may be used by the processing unit

, the details of which are provided below with reference to FIG. 5.

At step 308, the method comprises identifying a text position for the restructured text based on at least one of: the one or more user parameters, the one or more user activities, and the one or more VST parameters. In an implementation, the identifying the text position further comprises identifying a location (e.g., an anchoring location) and an anchoring type for the restructured text. In an implementation the identifying the text position is based on a segmentation of one or more sentences in the restructured text to generate one or more text segments; and
an alignment of the one or more text segments. This may further comprise a text simplification of the one or more text segments, a text reduction of the one or more text segments, and a text paraphrasing of the one or more text segments, wherein the text simplification, the text reduction, and the text paraphrasing is based on a complexity analysis of the one or more text segments.

At step 310, the method comprises presenting the restructured text based on the identified text position. In an implementation, the presenting of the restructured text is further based on one or more content parameters. The OU [206] may be used by the processing unit [102], the details of which are provided below with reference to FIG. 6. In an implementation, the one or more content parameters may be based on one or more of: a set of typographic parameters, an AR device rendered environment parameter, a content density per degree of field-of-view (FOV), and a real world environment parameter. In an implementation, the presenting the restructured text may include comparing a text simplification value of the one or more text segments with a pre-defined text simplification threshold value; and generating a text simplification score based on the comparison. In an implementation, the presenting the restructured text may further include comparing a text positioning value of the one or more text segments with a pre-defined text positioning threshold value; and generating a text positioning score based on the comparison. In an implementation, the presenting the restructured text may further include comparing a text visibility value of the one or more text segments with a pre-defined text visibility threshold value; and generating a text visibility score based on the comparison.

FIG. 4 is a block diagram illustrating an example configuration of analyzer and extraction unit (AEU) [202], according to various embodiments. In an example implementation, as shown in FIG. 4, the AEU [202] may include a VST Parameters Extraction Unit [402], a Background Parameters Extraction Unit [404], a User Parameters Extraction Unit [406], a Senor Data Extraction Unit [408], a User field of view (FOV) Analysis Unit [410], a Background Analysis Unit [412], a User Activity Classification Unit [414], a Context Analysis and Extraction Unit

, a Content Rendering Unit [418], a Content Analysis Unit [420], a Typographic Parameter Extraction Unit [422], a Content Parameter Extraction Unit [424], a Content Layout Type Extraction Unit [426], and a Text Extraction Unit [428], each of which may include various circuitry and/or executable program instructions.

The AEU [202] receives data from the AR based device as well as the content, e.g., the complete text that is to be processed and the real-world environment data. The VST Parameters Extraction Unit [402] extracts the VST parameters from the data received from the AR based device, such as, the VST glasses. The VST parameters include, but not limited to, Field of View (FOV), resolution, halation, etc. The Background Parameters Extraction Unit [404] extracts the background parameters or the real-world data parameters from the data from the real-world environment. The AR based device may comprise one or more sensors, such as, but not limited to, an eye tracking camera, a gyroscope, and an accelerometer. The sensors may collect and provide sensory data to the Senor Data Extraction Unit [408]. The sensors may also collect data from the user, that is related to user parameters. This data is provided to the User Parameters Extraction Unit

. The User Parameters Extraction Unit [406] extracts user parameters such as, but not limited to, head movement (in degrees), body movement (which indicates activities such as sitting, walking, etc.). The Senor Data Extraction Unit [408] provides data to the User FOV Analysis Unit

which determines FOV of the user for viewing content. The Background Parameters Extraction Unit [404] provides the extracted background parameters (or the real-world data parameters) to the Background Analysis Unit [412]. The Background Analysis Unit [412] determines the background properties like brightness, colour blending, etc. For example, the data in the content is present such that the text is camouflaged due to the real-world environment scenes/colours, then some properties may need to be changed so that the text in the data is clearly visible in the environment. The User Activity Classification Unit [414] receives data from the User Parameters Extraction Unit [406] and may classify the data based on user activities. The user activities may include, but not limited to, scrolling, typing, object interaction (such as, pinching the screen, virtually touching subjects seen in VST glasses, etc.). The output of the User Activity Classification Unit [414] is provided to the Context Analysis and Extraction Unit [416] which analyses the context for further processing of the data for presenting to the user on the AR based device. The output of the User FOV Analysis Unit [410] and the Background Analysis Unit [412] is provided to the Content Rendering Unit [418] which further renders the content to the Content Analysis Unit [420]. The Content Analysis Unit [420] analyses the content and provides the content to the Content Parameter Extraction Unit [424] that is connected to the Typographic Parameter Extraction Unit [422], the Content Layout Type Extraction Unit [426], and the Text Extraction Unit [428]. The Content Parameter Extraction Unit [424] may extract one or more content parameters from the data provided. The Typographic Parameter Extraction Unit [422] extracts the typographic parameters such as, but not limited to, glyph, legibility, font, width, weight, resolution, halation, and screen door. The one or more content parameters may relate to typography, AR/VR rendered environment, and content density per degree of FOV. Also, the Content Layout Type Extraction Unit [426] extracts/identifies the layout type of the text. These layout types may be based on view group type of the content like TextView, EditText, ScrollView, etc. as generally known in the art. Thus, the AEU [202] may facilitate in identifying one or more layout types for a complete text, and also in extracting the one or more VST parameters, the one or more layout types, the one or more user parameters, the one or more user activities, and one or more content parameters.

In an implementation, AEU [202] may implement artificial intelligence (AI) models for calculation/extraction of various parameters. For example, for user activity classification, the sensor data may be provided to the User Activity Classification Unit [414] which may perform various operations based on techniques such as, for example, but not limited to, inverse kinematics, Fisher Vector—Hidden Markov Model, Multiple Kernel Learning—Support Vector Machine, to predict output probabilities for various activities such as, for example, but not limited to, walking, running, standing, sitting, sleeping, etc. Similarly, in another example, for FOV calculation, the sensor data may be provided to the User FOV Analysis Unit [410] which may implement AI based techniques for calculation of FOV in degrees and provide the final output for further processing.

FIG. 5 is a block diagram illustrating an example configuration of complexity analysis and segmentation unit (CASU) [204], according to various embodiments. In an example implementation, as shown in FIG. 5, the CASU [204] comprises a Text Complexity Classification Unit [502], a Text Segmentation Unit [504], a Text Simplification Identification Unit [506], a Text Reduction Identification Unit [508], a Text Paraphrasing Identification Unit [510], a Text Position Identification Unit [512], a Text Anchoring Identification Unit [514], a Text Visibility Checking Unit [516], a Content Visibility Threshold Unit [518], a Content Simplification Threshold Unit

, and a Content Positioning Threshold Unit [522], each of which may include various circuitry and/or executable program instructions.

The output of the AEU [202] is provided to the CASU [204]. The data from the AEU [202] may be provided to the Text Complexity Classification Unit [502]. This data may comprise an extracted text, information related to FOV, and typographic parameters. The data is analysed by the Text Complexity Classification Unit [502] and classified on the basis of the text complexity such as, but not limited to, length of text, text occupancy per degree. The Text Segmentation Unit [504] generates one or more text segments. These one or more text segments are generated based on splitting of the text. The segmented text is provided to the Text Simplification Identification Unit

, the Text Reduction Identification Unit [508], and the Text Paraphrasing Identification Unit

. The Text Simplification Identification Unit [506] predicts the text simplification along with replacing text with symbols for rendering the text in the optimum field of view and readability of the user. This Text Simplification Identification Unit [506] may implement AI/ML based models, such as readability level model, and other reinforcement learning techniques to generate a simplified text along with a probability score related to this simplification of the text for further processing. For example, a text “XYZ beach was originally incorporated in 1920 as the town of XYZ” may be simplified as “XYZ beach was founded in 1920”. The Text Reduction Identification Unit [508] predicts the text reduction for rendering the text in the optimum field of view and readability of the user. This Text Reduction Identification Unit [508] may implement AI based models, position enhanced - convolutional neural networks, along with implementation of other techniques to reduce text length along with a probability score related to this reduced text length for further processing. The Text Paraphrasing Identification Unit [510] predicts the text paraphrasing by predicting splitting of the text in increased number of paragraphs for the optimum field of view and readability for the user. The Text Paraphrasing Identification Unit [510] may implement AI based models for paraphrasing the text. This paraphrasing of the text may be based on removing duplicate data present in the text. The Text Paraphrasing Identification Unit [510] may provide the paraphrased text with removed duplicates along with a probability score related to this paraphrased text for further processing. Based on receiving the probability scores related to the simplification of the text, the reduced text length, and the paraphrased text, an overall content simplification score may be generated. This content simplification score is compared with a content simplification threshold score in the Content Simplification Threshold Unit [520]. In an example implementation, the content simplification threshold score is fixed at 0.75. The output is sent to the output unit

, for rendering the final output, in case the overall content simplification score is greater than the content simplification threshold score. The segmented text along with the extracted parameters is provided to the Text Visibility Checking Unit [516]. The Text Visibility Checking Unit [516] checks for the visibility of the text based on various parameters, such as, but not limited to, the user movement, text background, real-world background, and typographic parameters such as resolution of the text, font of the text, etc. The Text Visibility Checking Unit [516] may include a trained unit that is trained based on artificial intelligence/machine learning (AI/ML) models. This training may involve providing the training images to the model(s), computing texture features, training the classifier based on the computed training features and a set of font feature for training text label that are provided to the model from external sources. Thus, the new images are provided to the model and again the texture features are computed. Further, classification of the new images is performed using the trained classifier, and font features for text label are provided to the trained classifier. Based on the above inputs, the trained classifier generates a decision related to readability of the text, as to whether the text is readable or not. After checking the visibility, a content visibility score may be generated by the Text Visibility Checking Unit [516] which is compared with a content visibility threshold score in the Content Visibility Threshold Unit [518]. In an implementation, classification and separation of typographic features of text is done using CNN and probability scores of typographic features. After this, correlation of typographic features with input parameters (such as, brightness, VST parameters, etc.) is made. If the correlation between any of the VST parameters and any of the typographic parameters is high, then that correlation score may correspond to the content visibility score. Thus, in an implementation, the content visibility improvement may be done by reducing the correlation by varying the typographic parameters in the OU [206]. The Text Position Identification Unit [512] and Text Anchoring Identification Unit [514] are responsible for anchoring a text at a fixed position for the user based on various parameters such as, but not limited to, user movement (such as, head movement, body movement, etc.), real world parameters, etc. For example, a user is moving in a marketplace wearing the AR based device, then based on the user movement (e.g., walking, in this example), the text position and anchoring decision might be taken to anchor a relevant selected text to the top right corner of the FOV of the AR based device. The anchoring decision may be taken to fix a position/location of the text according to, for example, the user movement and also for defining an anchoring type (such as, a world anchor which fixes the position and rotation of the text at a specific location in the world, an edge anchor which fixes the position and rotation of the text at a specific location in the world with the text oriented in permanence towards the user, a screen anchor which fixes the position and rotation of the text relatively to the user's head, a body anchor fixes the position and rotation of the text relatively to the user body, etc.) The Text Position Identification Unit [512] may implement a decision tree model that generates a final result based on majority voting and averaging. The Text Position Identification Unit [512] predicts the text position for rendering the text in the optimum field of view and readability of the user. For example, a Convolutional Neural Network (CNN) may be used for image data processing and providing classification probabilities of anchoring type (world anchor, edge anchor, screen anchor, body-anchor, etc.). These probabilities are considered to be a threshold for providing the anchor type for the text. If the probabilities significantly deviate from each other, (e.g., difference of probabilities are very large), then it is considered as threshold. When the probability is high (e.g., threshold is met) then Anchor type is send along with the probability to the OU [206]. The Text Anchoring Identification Unit [514] implements AI/ML models to predict the text anchoring for rendering the text in the optimum field of view and readability of the user. Based on this positioning of the content, a content positioning score may be generated. This content positioning score is compared with a content positioning threshold score in the Content Positioning Threshold Unit [522]. If the content simplification threshold score is significant, then the simplified text for readability along with the content positioning score is provided to the OU [206], if the content visibility threshold score is significant, then the text typographic improvement parameters along with the content visibility score are provided to the OU [206], and if content positioning threshold score is significant, then the text anchor type and coordinates for positioning along with the content positioning score are provided to the OU [206].

The output of the AEU [202] and CASU [204] is provided to the OU [206]. FIG. 6 is a block diagram illustrating an example configuration of the OU [206], according to various embodiments. From CASU [204], the score(s) greater than their respective threshold(s) for text processing for individual units, and coordinates for positioning are received at the Parameter Combination Unit [602] of the OU [206]. From AEU [202], FOV (degrees), background parameters, typographic parameters, layout type (or a view-group type), VST Parameters are received at the Parameter Combination Unit [602] of the OU [206]. At the Parameter Combination Unit [602], the parameters are combined and further processed. Based on all the inputs, the text is finally simplified by the Text Simplification Unit [604], positioned by the Text Positioning/Anchoring Unit [606], and visually enhanced Text Visibility Enhancement Unit [608] for generating the output that needs to be rendered to the user via the Output Text Rendering Unit

.

According to an example, a user may have a grocery list in hand or preset (e.g., specified) in the AR based device. The user goes to a market to buy the things that are written in the grocery list. Thus, when the user provides the grocery list to the AR based device, such as the VST glasses, the important information from the grocery list is identified. That is, the items from the list are identified. This is done by the AEU [202]. The AEU [202] also identifies and extracts the parameters, e.g., the user parameters, background parameters, VST parameters, etc. for presenting the final text to the user in an effective manner. In another example, the user may have a recipe that is provided to the AR based device and goes to the market with that recipe. The important information from the recipe, for example, the grocery items from that recipe are identified for the user to buy. The identified important information is presented to the user in the FOV of the user at the AR based device. The text from the surroundings is extracted for being presented to the user. The text is analysed, and complexity of the text is reduced by the CASU [204] for presenting to the user. Here, the text extracted by the AEU [202] may be subject to text simplification, text reduction, and text paraphrasing by the CASU [204]. Since the user is walking in the market, the identified important information is anchored to a position/location of the FOV of the user in such a manner that the same is not a hinderance to the user when the user wants to look at the surroundings, and presented so as the user does not find difficulty in looking at the important items that the user needs to buy. For example, the identified important information is anchored at the top right corner of the FOV of the user, and is anchored there so that when the user moves his/her head, the identified important information also moves according to the movement of the user to keep at the same top right corner for the user to see. The text from the surroundings is also gathered/extracted and some redundant text, that is, the text not relevant for the user's context that is based on the grocery list, is also identified. Irrelevant text is either removed by assessing FOV of the user or presented in a non-intruding manner to the user. Also, the relevant information is presented to the user FOV. This relevant information may be based on the context of the user, that is, the grocery list or the recipe preset in the AR based device. In another example, where the user is moving in a surrounding that is camouflaging the text to be shown to the user, the text is again processed and modified so that the same is not camouflaged by the surroundings. This may include, for example, modifying colour, font size, font style, text drawing style, text drawing style such as, but not limited to, billboard style, outline style, shadow style, plain style, flat billboard, and curved billboard.

The present disclosure further discloses a non-transitory computer-readable storage medium storing instructions for text presentation in an augmented reality (AR) based device. The instructions include executable code which, when executed by one or more units of a system, causes a processing unit [102] of the system [100] to identify one or more layout types for a complete text. The executable code, when executed, causes the processing unit [102] and/or the system to: restructure the complete text based on one or more visual see through (VST) parameters, the one or more layout types, and a text occupancy per degree value; identify a text position for the restructured text based on at least one of: one or more user parameters, one or more user activities, and the one or more VST parameters; and present the restructured text based on the identified text position.

The present disclosure provides a novel approach for text presentation in an augmented reality (AR) based device. The present disclosure provides an approach for text presentation in an augmented reality (AR) based device that has enhanced visibility. The disclosure is able to restructure the text based on various significant parameters. The disclosure is able to anchor the text position based on various significant parameters. The disclosure is able to extract a relevant text from a complete text, where the relevant text is shown to the user in an effective manner in the field of view (FOV) to the user. While the disclosure has been illustrated and described with reference to various example embodiments, it will be appreciated that many changes can be made in the various embodiments without departing from the principles of the disclosure. These and other changes in the various embodiments will be apparent to those skilled in the art from the disclosure herein, whereby it is to be distinctly understood that the foregoing descriptive matter to be implemented merely as illustrative of the disclosure and not as limitation. It will also be understood that any of the embodiment(s) described herein may be used in connection with any other embodiment(s) described herein.

What is claimed is:

1. A method for text presentation in an augmented reality (AR) based device, the method comprising:
identifying one or more layout types for a complete text;
restructuring the complete text based on one or more visual see through (VST) parameters, the one or more layout types, and a text occupancy per degree value;
identifying a text position for the restructured text based on at least one of: one or more user parameters, one or more user activities, and the one or more VST parameters; and
presenting the restructured text based on the identified text position.

2. The method as claimed in claim 1, wherein the identifying the text position further comprises identifying a location and an anchoring type for the restructured text.

3. The method as claimed in claim 1, wherein the presenting of the restructured text is further based on one or more content parameters.

4. The method as claimed in claim 3, wherein the one or more content parameters are based on one or more of: a set of typographic parameters, an AR device rendered environment parameter, a content density per degree of field-of-view (FOV), and a real world environment parameter.

5. The method as claimed in claim 3, wherein the restructuring the complete text comprises:
extracting a relevant text from the complete text for display, based on a visual context, the one or more content parameters, and at least a subset of the one or more VST parameters.

6. The method as claimed in claim 1, wherein the identifying the text position is based on:
a segmentation of one or more sentences in the restructured text to generate one or more text segments; and
an alignment of the one or more text segments.

7. The method as claimed in claim 6, wherein the method further comprises:
a text simplification of the one or more text segments, a text reduction of the one or more text segments, and a text paraphrasing of the one or more text segments, wherein the text simplification, the text reduction, and the text paraphrasing is based on a complexity analysis of the one or more text segments.

8. The method as claimed in claim 6, wherein the presenting the restructured text further comprises:
comparing a text simplification value of the one or more text segments with a specified text simplification threshold value; and
generating a text simplification score based on the comparison.

9. The method as claimed in claim 6, wherein the presenting the restructured text further comprises:
comparing a text positioning value of the one or more text segments with a specified text positioning threshold value; and
generating a text positioning score based on the comparison.

10. The method as claimed in claim 6, wherein the presenting the restructured text further comprises:
comparing a text visibility value of the one or more text segments with a specified text visibility threshold value; and
generating a text visibility score based on the comparison.

11. The method as claimed in claim 3, wherein prior to identifying the one or more layout types for the complete text, the method comprises:
extracting the one or more VST parameters, the one or more layout types, the one or more user parameters, the one or more user activities, and the one or more content parameters.

12. An augmented reality (AR) based device, comprising:
at least one processor, comprising processing circuitry;
at least one memory connected to at least one processor,
wherein at least one processor, individually and/or collectively, is configured to:
identify one or more layout types for a complete text;
restructure the complete text based on one or more visual see through (VST) parameters, the one or more layout types, and a text occupancy per degree value;
identify a text position for the restructured text based on at least one of: one or more user parameters, one or more user activities, and the one or more VST parameters; and
present the restructured text based on the identified text position.

13. The augmented reality based device as claimed in claim 12, wherein at least one processor, individually and/or collectively, is configured to identify a location and an anchoring type for the restructured text.

14. The augmented reality based device as claimed in claim 12, wherein at least one processor, individually and/or collectively, is configured to present the restricted text based on one or more content parameters.

15. The augmented reality based device as claimed in claim 14, wherein the one or more content parameters are based on one or more of: a set of typographic parameters, an AR device rendered environment parameter, a content density per degree of field-of-view (FOV), and a real world environment parameter.

16. A non-transitory computer readable recording medium storing computer instructions that when executed by a processor of an augmented reality (AR) based device, cause the augmented reality (AR) based device:
identifying one or more layout types for a complete text;
restructuring the complete text based on one or more visual see through (VST) parameters, the one or more layout types, and a text occupancy per degree value;
identifying a text position for the restructured text based on at least one of: one or more user parameters, one or more user activities, and the one or more VST parameters; and
presenting the restructured text based on the identified text position.

17. A non-transitory computer readable recording medium of claim 16, wherein the identifying the text position further comprises identifying a location and an anchoring type for the restructured text.

18. A non-transitory computer readable recording medium of claim 16, wherein the presenting of the restructured text is further based on one or more content parameters.

19. A non-transitory computer readable recording medium of claim 18, wherein the one or more content parameters are based on one or more of: a set of typographic parameters, an AR device rendered environment parameter, a content density per degree of field-of-view (FOV), and a real world environment parameter.

20. A non-transitory computer readable recording medium of claim 18, wherein the restructuring the complete text comprises:
extracting a relevant text from the complete text for display, based on a visual context, the one or more content parameters, and at least a subset of the one or more VST parameters.
